(19) United States
(12) Patent Application Publication
(10) Pub. No.: US 2025/0374937 A1
(43) Pub. Date: Dec. 11, 2025

(54) SYSTEMS AND METHODS FOR PREPARING FREQUENCY INFUSED BEVERAGES

(71) Applicant: WholeHarmony, LLC, Centerbrook, CT (US)

(72) Inventor: Stacey Wood, Centerbrook, CT (US)

(73) Assignee: WholeHarmony, LLC, Ceterbrook, CT (US)

(21) Appl. No.: 19/235,414

(22) Filed: Jun. 11, 2025

Related U.S. Application Data
(60) Provisional application No. 63/658,744, filed on Jun. 11, 2024.

(51) Int. Cl. A23L 2/38; A23L 2/56; A23L 5/30; B67C 3/28

(52) U.S. Cl. CPC A23L 2/38; A23L 2/56; A23L 5/32; B67C 3/28

(57) ABSTRACT

In accordance with at least one aspect of this disclosure, an apparatus for preparing a beverage with an infused frequency includes, a vibration inducer. The vibration inducer includes a diaphragm configured to be placed in or proximate a liquid being bottled and a vibration generator operatively connected to the diaphragm to drive the diaphragm at a predetermined frequency to induce a measurable pressure pulsation in the fluid being bottled. The apparatus further includes a controller configured to receive an instruction of the predetermined frequency and cause the vibration generator to vibrate at the predetermined frequency. The predetermined frequency can be selected as a function of a desired healing effect of the beverage preparation, for example, the predetermined frequency can align with one of the seven main chakra frequencies.

### CROSS-REFERENCE TO RELATED APPLICATIONS

This application claims priority to and the benefit of U.S. Provisional Application No. 63/658,744, filed Jun. 11, 2024, the entire contents of which are herein incorporated by reference in their entirety.

### TECHNICAL FIELD

The present disclosure relates to beverages and beverage preparation and more particularly to systems and methods for producing beverages injected or infused with certain frequencies.

### BACKGROUND

A chakra is an energy center in the body connected to different dimensions of our well-being, including physical, emotional and spiritual aspects. The word “chakra” comes from Sanskrit and translates to “wheel” or “disk.” There are seven main chakras in the human body, forming the chakra system, each corresponding to different areas and functions.

The concept of chakras originated in ancient Indian traditions and has been adopted by various holistic healing practices worldwide. These energy centers are believed to spin and vibrate at different frequencies, influencing our overall health and balance.

Each of the seven chakras in the body holds unique significance and is associated with specific qualities and characteristics. For example, the root chakra, located at the base of the spine, is connected to feelings of stability and security. The heart chakra, located in the center of the chest, is associated with love and compassion.

Understanding and balancing these chakras can promote harmony and well-being in our lives. Various techniques and practices, such as meditation, yoga, sound therapy, and energy healing, are used to balance and activate the chakras, enhancing physical health, emotional well-being, and spiritual growth.

Such conventional balancing techniques have generally been considered suitable, however, there are currently no options for one to promote harmony and well-being via chakra balancing using beverages. Accordingly, there is an ever-present need in the art for systems and methods for producing beverages injected or infused with certain frequencies. This disclosure provides a solution for this need.

### SUMMARY

In accordance with at least one aspect of this disclosure, an apparatus for preparing a beverage with an infused frequency includes, a vibration inducer. The vibration inducer includes a diaphragm configured to be placed in or proximate a liquid being bottled and a vibration generator operatively connected to the diaphragm to drive the diaphragm at a predetermined frequency to induce a measurable pressure pulsation in the fluid being bottled. The apparatus further includes a controller configured to receive an instruction of the predetermined frequency and cause the vibration generator to vibrate at the predetermined frequency. The predetermined frequency can be selected as a function of a desired healing effect of the beverage preparation, for example, the predetermined frequency can align with one of the seven main chakra frequencies.

The vibration inducer can further include an actuator configured to drive the diaphragm while the vibration generator vibrates at the predetermined frequency. The actuator can be a small actuator, such as an actuator having a stroke length of less than 10 mm, or a stroke length of less than 5 mm, or a stroke length of less than 4 mm. In certain embodiments the actuator can include a crystal. In certain embodiments, the actuator can be or include a piezoelectric actuator.

In certain embodiments, the measurable pressure pulsation induced via the vibration inducer is greater than an ancillary pressure pulsation induced by bottling equipment other than the vibration inducer. In certain embodiments, the measurable pressure pulsation induced via the vibration inducer is more than two times greater than an ancillary pressure pulsation induced due to other bottling equipment. It is noted that should any ancillary pressure pulsation be induced in the liquid by bottling equipment other than the vibration inducer, this ancillary pressure pulsation occurs at a frequency different than the predetermined frequency, and at a much lower magnitude and can therefore be ignored.

In certain embodiments, the predetermined frequency is between 390 to 970 hz, for example, about 396 hz or about 417 hz or about 528 hz or about 639 hz or about 741 hz or about 852 hz or about 936 hz. In certain embodiments, the predetermined frequency is equal to one of 396 hz or 417 hz or 528 hz or 639 hz or 741 hz or 852 hz or 936 hz to align with one of the seven main chakra frequencies, e.g., the root chakra, the sacral chakra, the solar plexus chakra, the heart chakra, the throat chakra, the third eye chakra, and the crown chakra, respectively.

In certain embodiments, the apparatus can further include a mixing vessel configured to mix a liquid base and one or more flavoring ingredients together to generate a mixed liquid, a bottling vessel configured to deposit the mixed liquid into a respective bottle for consumption; and a pump disposed between the mixing vessel and the bottling vessel to draw the mixed liquid from the mixing vessel and provide the mixed liquid to the bottling vessel.

The pump includes an inlet side and an outlet side and in certain embodiments, the vibration inducer is positioned upstream of the inlet side of the pump. The apparatus can also include a conduit (e.g., a flexible tubing or piping) extending from the mixing vessel and the bottling vessel, where a first portion of the conduit extends from the mixing vessel to the inlet side of the pump and where a second portion of the conduit extends from the outlet side of the pump to the bottling vessel. In certain such embodiments, the vibration inducer can be disposed in the first portion of the conduit.

In certain embodiments, the mixing vessel, the pump, the bottling vessel, the vibration inducer, and the conduit together can form a single bottling station. The apparatus can include a plurality of bottling stations fluidly isolated from one another. Each respective vibration inducer of each bottling can be configured to operate at a different respective predetermined frequency, e.g., each bottling station can be dedicated to bottling a beverage preparation having been infused with a different chakra frequency. In certain embodiments, the one or more flavoring ingredients provided to each respective mixing vessel can be selected as a function of the respective predetermined frequency. For example, certain flavoring ingredients are more compatible with balancing certain chakras when combined with the respective predetermined frequency.

In accordance with at least one aspect of this disclosure, a method for preparing a beverage with an infused frequency, can include the steps of inducing, during a bottling process, a measurable pressure pulsation in a liquid to be bottled using a vibration generator operating at a predetermined frequency. The method can further include mixing a base liquid with one or more flavoring ingredients in a mixing vessel to generate a mixed liquid, providing the mixed liquid from the mixing vessel to a bottling vessel downstream of the mixing vessel, and depositing the mixed liquid from the bottling vessel to a bottle for consumption. In certain embodiments, the inducing step occurs during the providing step, i.e., after the mixing step and before the bottling step, upstream of any pump used to provide the mixed liquid from the mixing vessel to the bottling vessel. In certain embodiments, the predetermined frequency induced in the liquid can be one of about 396 hz or about 417 hz or about 528 hz or about 639 hz or about 741 hz or about 852 hz or about 936 hz.

In accordance with at least one aspect of this disclosure, a novel beverage preparation is provided. The beverage preparation can include a base liquid mixed with one or more flavoring ingredients, and can further include an infused frequency configured to promote healing of one of the seven main chakras as a function of the infused frequency. Healing properties of the beverage may include promoting sensations of improved physical health, emotional well-being, and spiritual growth. Embodiments of the beverage preparation can be made by any one or more of the embodiments of the process described herein and using any one or more embodiments of the bottling apparatus shown and described herein.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIG. 1 is a schematic diagram of an apparatus in accordance with this disclosure, showing an exemplary bottling station for preparing a beverage with an infused frequency;

FIG. 2 is a schematic diagram of an exemplary vibration inducer included in the apparatus shown in FIG. 1;

FIG. 3 is a schematic diagram of the apparatus of FIG. 1 showing a plurality of bottling stations;

FIGS. 4-10 are pressure spectra showing measured pressure pulsations induced in the beverage at several predetermined frequencies during the bottling process;

FIG. 11 is a flow chart depicting an exemplary embodiment of a method for preparing a beverage with an infused frequency; and

FIG. 12 depicts \ exemplary embodiments of a beverage with an infused frequency.

### DETAILED DESCRIPTION

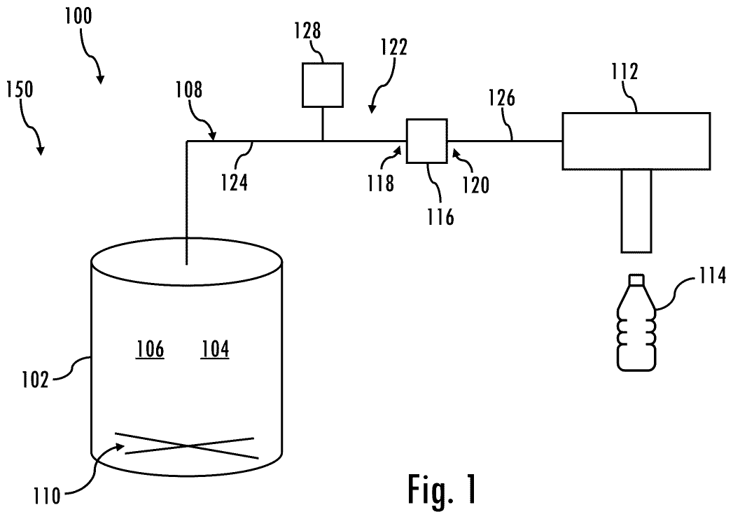

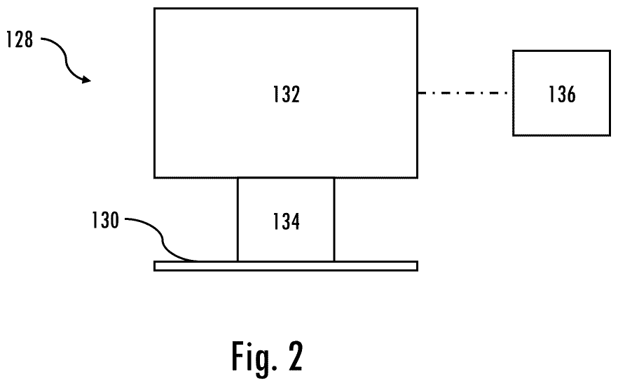

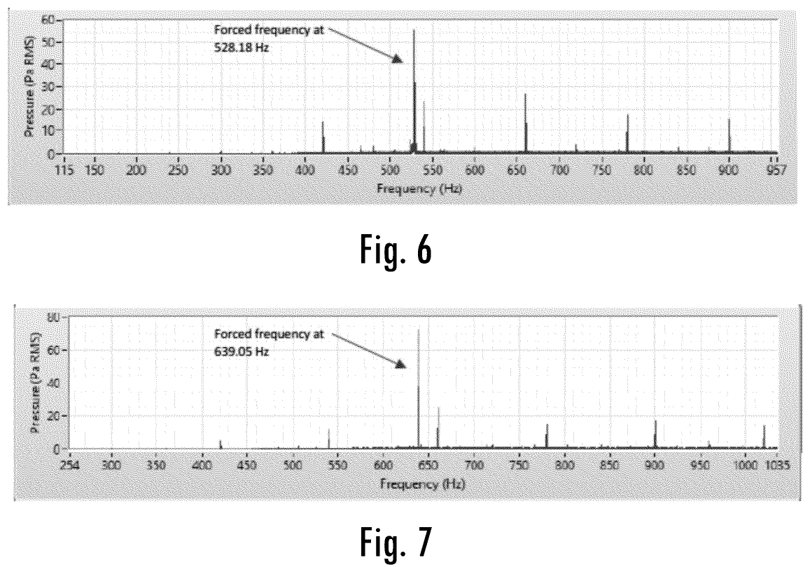

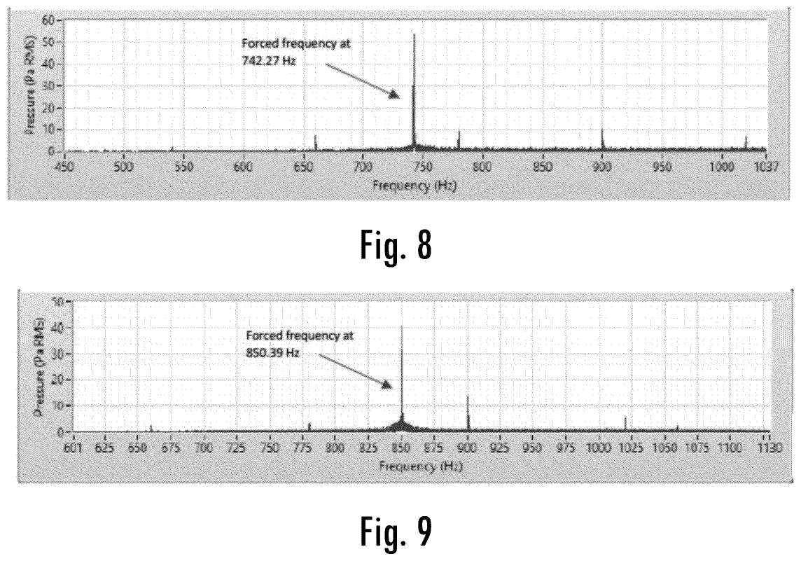

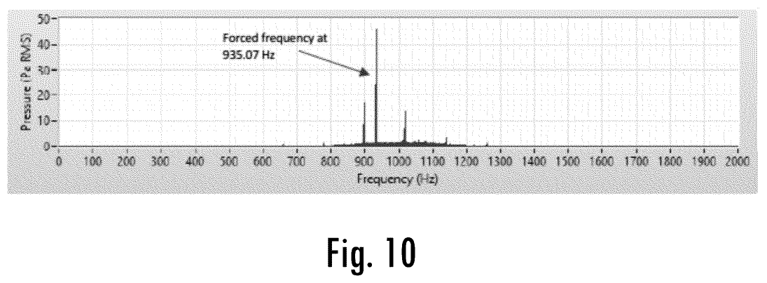

Reference will now be made to the drawings wherein like reference numerals identify similar structural features or aspects of the subject disclosure. For purposes of explanation and illustration, and not limitation, an illustrative view of an embodiment of an apparatus in accordance with the disclosure is shown in FIG. 1 and is designated generally by reference character 100. Other embodiments and/or aspects of this disclosure are shown in FIGS. 2-12.

Embodiments of the systems and methods described herein can be used to produce “frequency infused beverages” configured and adapted to promote balance and activation of the chakras, enhancing one's physical health, emotional well-being, and spiritual growth.

### The Significance of Chakras in Holistic Healing

Chakras play a crucial role in holistic healing practices, serving as vital energy centers that contribute to our overall well-being. When our chakras are balanced and aligned, energy flows freely throughout our physical body, promoting optimal health and vitality.

Holistic healing approaches recognize that imbalances or blockages in the chakras can lead to physical ailments, emotional disturbances, and spiritual disconnect. By addressing these imbalances through various healing modalities, practitioners aim to restore harmony and promote self-healing.

Chakras are seen as gateways to higher consciousness and spiritual growth, providing a framework for understanding the interconnectedness of our physical, emotional, and spiritual selves. By working with the chakras, individuals can deepen their self-awareness, expand their consciousness, and tap into their inner wisdom.

Holistic healing practices often involve techniques such as energy healing, crystal therapy, aromatherapy, and meditation to balance and activate the chakras. These practices not only promote physical healing but also support emotional well-being and spiritual development.

The seven chakras in the human body are believed to be located along the central channel of the body, from the base of the spine to the crown of the head. Each chakra is associated with specific colors, elements, sounds, and qualities, symbolizing the diverse dimensions of our well-being, encompassing the physical, emotional and spiritual realms.

Each chakra will be described in more detail below, but in summary, the root chakra (Muladhara) is located at the base of the spine and is associated with the color red. It represents our foundation, stability, and sense of security. The sacral chakra (Svadhisthana) is located in the lower abdomen and is associated with the color orange. It governs our creativity, sexuality, and emotional well-being. The solar plexus chakra (Manipura) is located in the upper abdomen and is associated with the color yellow. It relates to our personal power, confidence, and self-esteem. The heart chakra (Anahata) is located in the center of the chest and is associated with the color green. It represents love, compassion, and emotional balance. The throat chakra (Vishuddha) is located in the throat area and is associated with the color blue. It governs our communication, self-expression, and authenticity. The third eye chakra (Ajna) is located between the eyebrows and is associated with the color indigo. It relates to our intuition, inner wisdom, and spiritual insight. The crown chakra (Sahasrara) is located at the top of the head and is associated with the color violet or white. It represents our connection to higher consciousness, spirituality, and divine wisdom.

By understanding and working with these seven main chakras, individuals can cultivate balance, harmony, and well-being in their lives.

### Holistic Approaches to Chakra Balancing

Chakra balancing is integral to holistic wellness. It influences the health of the physical body and emotional and spiritual well-being. By employing various techniques, individuals can restore harmony and vitality to their chakras, promoting overall well-being.

There are many conventional techniques to restore harmony and balance the chakras, including sound therapy, incorporating color, crystal and aromatherapy, meditation and energy healing, aromatherapy and botanicals, yoga and physical therapy, affirmations and mantras, and lifestyle practices and self-care.

Incorporating self-care practices into daily life is essential for maintaining chakra balance. Engaging in activities that nourish the body, mind, and spirit, such as mindfulness, creative expression, and positive relationships, supports overall well-being and fosters a deeper connection to the self. Embodiments of a healing beverage produced by the novel system and methods disclosed herein is one way of incorporating a lifestyle and self-care practice into one's daily life.

### The Chakras

### Crown Chakra

The crown chakra, a gateway to universal connection and spiritual awareness, is the highest energy center in the body. When aligned, it fosters a deep sense of peace, purpose, and oneness with the universe. The crown chakra, or Sahasrara in Sanskrit, is the seventh and highest chakra in the body's energy system. Located at the top of the head, it is associated with the color violet or white and the element of thought or pure consciousness.

The crown chakra represents spiritual connection—feeling linked to something greater than yourself; inner wisdom—access to higher knowledge and intuition; enlightenment—deep awareness and understanding of your purpose; and divine energy—a flow of universal love and peace. A balanced crown chakra brings clarity, intuition, and a profound sense of unity with the world.

The crown chakra symbol is often depicted as a thousand-petaled lotus, representing infinite consciousness and spiritual awakening. It signifies the ability to transcend ego, embrace higher wisdom, and align with divine energy.

When the crown chakra is blocked, it can cause emotional, mental, and physical imbalances. exemplary imbalance can include emotional and spiritual symptoms such as disconnection from purpose and spirituality; feelings of isolation or loneliness; lack of clarity or inspiration; excessive attachment to material things; and cynicism, skepticism, or closed-mindedness. mental and physical symptoms of blocked crown chakra can include brain fog or difficulty concentrating; chronic headaches or migraines; fatigue or low energy levels; insomnia or sleep disturbances; if you're experiencing these signs, crown chakra healing can help restore balance.

Embodiments of the beverage 200 can be infused with lavender, lemon, and a frequency of 936 hz, the crown chakra frequency. This frequency and combination of ingredients supports spiritual alignment, mindfulness, and higher consciousness, which can help open a blocked crown chakra, promoting feelings of deep connection to yourself, others, and the universe, harmony, clarity, and peace.

### Third Eye Chakra

The Third Eye Chakra, the center of intuition and inner vision, allows one to see beyond the physical world and connect with deeper truth. When balanced, it opens the door to clarity, insight, and spiritual awareness.

The third eye chakra, or Ajna in Sanskrit, is located between the eyebrows and is often associated with the color indigo and the element of light. This energy center governs intuition, imagination, mental clarity, and perception, bridging the gap between the physical and spiritual realms.

When the third eye chakra is balanced, one may feel intuitive—a deep trust in their inner guidance; insightful—aligned with their higher consciousness; and mentally focused—free from mental fog and indecision.

An imbalanced or blocked third eye chakra, however, can manifest as: difficulty trusting instincts, overthinking, or feelings of disconnection; lack of imagination, poor decision-making, or the inability to envision future possibilities; and/or headaches, tension in the brow area, or sleep disturbances.

Embodiments of the beverage 200 can be infused with organic passionflower and dragon fruit puree, and a frequency of 144 hz, which aligns with the third eye chakra frequency to radiate inner knowing and vision. this frequency can help to unlock one's intuition, expand one's imagination, and align with one's true purpose.

### Throat Chakra

The throat chakra—the center of communication and truth—enables one to connect with the world through their voice. When balanced, it empowers clear communication, active listening, and the courage to align one's words with one's truest self.

The throat chakra, or Vishuddha in Sanskrit, is the fifth energy center in the body. Located at the throat, it governs self-expression, communication, and the ability to speak one's truth. Represented by the color blue and associated with the element of ether, this chakra connects mind to voice, allowing for clear, intentional expression.

When the throat chakra is balanced, one may experience: Confidence in expressing thoughts and feelings; Alignment between words and actions; and Openness to active listening and understanding.

When the throat chakra is blocked or imbalanced, symptoms might include: Fear of speaking up or being misunderstood; Excessive talking or difficulty listening; sore throat, thyroid imbalance, or neck tension.

Embodiments of the beverage 200 can be Infused with frequency of 741 hz, the throat chakra frequency, configured and adapted to harmonize communication and truth. Such embodiments can include nourishing botanicals like adaptogenic tulsi, antioxidant-rich elderberries, and soothing ginger, in addition to the 741 hz frequency, allowing this beverage to support clear self-expression while calming the body and mind.

### Heart Chakra

The heart chakra is an energy center that bridges between physical and spiritual self, promoting harmony in relationships and within oneself. The heart chakra, or Anahata in Sanskrit, is the fourth chakra in the body's energy system. Located at the center of the chest, near the heart, it is associated with the color green and the element of air. The heart chakra governs love, compassion, forgiveness, and emotional balance.

The heart chakra represents our ability to give and receive love. When in balance, it enables us to form meaningful relationships, foster self-love, and live harmoniously with others. It's the essence of connection, bridging the physical and spiritual aspects of our being.

When the heart chakra is imbalanced or blocked, it can manifest in emotional, physical, and behavioral symptoms: jealousy and resentment; fear of intimacy or vulnerability; difficulty forgiving past harms; overly critical of oneself or others; lack of empathy and disconnection; inability to form or maintain relationships; tightness in the chest or shoulders; difficulty breathing; and circulatory issues.

To balance the heart one may engage in practices that align with its energy and promote emotional balance, such as engaging with the heart chakra frequency. Embodiments of the beverage 200 include a beverage infused with a frequency of 639 hz, the heart chakra frequency, a frequency associated with harmonious relationships and emotional healing. This frequency encourages cells to communicate with love, tolerance, and understanding, making it an essential element in heart chakra alignment.

### Solar Plexus Chakra

The solar plexus chakra, often referred to as the powerhouse of one's energy system, plays a crucial role in shaping your personal power and self-esteem. The solar plexus chakra, known as Manipuri in Sanskrit, is located in the upper abdomen, just above the navel. Associated with the color yellow and the element of fire, this energy center governs self-esteem, willpower, and sense of purpose. It's the chakra of personal power, enabling you to manifest one's dreams, take decisive action, and maintain healthy boundaries.

When the solar plexus chakra is balanced, one can feel: confident and self-assured; motivated to achieve goals; and in control of your decisions and emotions.

An imbalanced solar plexus chakra, however, can manifest in various ways including: digestive issues, chronic fatigue, or nausea; self-doubt, low self-esteem, or constant worry; people-pleasing tendencies, unhealthy boundaries, and or tolerating disrespect in relationships. It is also believed the solar plexus chakra is closely linked to the gut, often referred to as the “second brain.” located near the stomach, it influences digestive health and gut instincts. This connection highlights the importance of maintaining a balanced diet and managing stress to support your physical and energetic well-being.

Embodiments of the beverage 200 can be infused with a frequency of 528 hz, the solar plexus frequency, calming chamomile, and energizing pineapple, where each sip is configured and adapted to promote nurturing your core energy center and balancing the solar plexus chakra.

### Sacral Chakra

The sacral chakra, known as Svadhisthana in Sanskrit, is the center of emotional and creative energy. Often associated with feminine energy, it represents the essence of flow, adaptability, and joy. The Sacral Chakra is the second energy center, located in the lower abdomen, just below the navel. It radiates the vibrant color orange and is closely tied to the element of water, symbolizing movement, adaptability, and emotional connection. This energy center influences our ability to experience pleasure, form meaningful relationships, and express creativity. While its energy is deeply feminine—representing creation, nurturing, and passion—it is universal in its invitation to embrace life's pleasures and emotional authenticity.

When balanced, the sacral chakra empowers one to: feel emotionally connected and expressive; tap into creativity and inspiration; experience joy, pleasure, and deep emotional intimacy. When imbalanced, one might feel: emotional numbness or instability; creative blocks or lack of motivation; guilt or shame around pleasure or connection; and/or fear of change or difficulty adapting to life's ebbs and flows.

Balancing the Sacral Chakra means embracing your emotional and creative self while fostering harmony in relationships and self-expression. The Sacral Chakra embodies the divine feminine—the energy of creation, nurturing, and flow. While this energy resonates deeply with women, its gifts of emotional expression and creativity are universal. Tuning into this chakra encourages everyone, regardless of gender, to embrace self-expression, passion, and emotional intimacy. Embodiments of the beverage 200 can be infused with tropical mango, lemon juice, and calming calendula, and a frequency of 417 hz to resonate with this energy center. Embodiments of the beverage 200 having infusion with this frequency can cleanse negative energy, inspiring emotional flow and wellness.

### Root Chakra

A crucial part of balancing mind, body, and spirit is the root chakra, the foundation of our energy system. Root chakra healing is essential for grounding and stabilizing your entire being. The root chakra, or Muladhara in Sanskrit, is the first chakra in the body's energy system. It is located at the base of the spine and serves as the foundation of our physical and energetic being. Represented by the vibrant color red, it symbolizes grounding, stability, and a deep connection to the earth.

The root chakra governs our basic needs for security, stability, and survival. It influences how we feel in our own skin, our ability to care for ourselves, and our sense of belonging. A balanced root chakra creates a strong foundation for physical, emotional, and spiritual well-being. The root chakra represents our connection to the earth and our foundation for safety and stability. When balanced, it provides a deep sense of security and confidence, enabling us to navigate life's challenges with resilience.

Signs of a balanced root chakra include: feeling safe and secure; confidence in meeting life's challenges; and a strong connection to the physical body and surroundings. Emotionally, the root chakra is closely tied to fear—a natural response tied to our sense of survival. When this chakra is balanced, fear transforms into inner peace, security, and confidence.

An imbalanced or blocked root chakra can lead to physical, emotional, and behavioral symptoms, affecting your overall well-being. For example, symptoms can include: anxiety or fear; feelings of insecurity; an obsession with material possessions; avoidance of responsibilities or procrastination; a tendency to overcompensate by accumulating possessions; difficulty staying grounded or focused; fatigue or sluggishness; lower back pain; and/or a general sense of instability.

Root chakra imbalances can stem from various physical, emotional, and environmental factors, such as: chronic stress or trauma; negative thinking patterns; financial insecurity; toxic relationships; and/or physical neglect or lack of self-care.

Among other things, embodiments of the beverage 200 can be used to balance the root chakra, for example embodiments of the beverage can include a nurturing blend infused with tulsi, elderberries, hibiscus and a frequency of 396 hz—intentionally infused to align with the root chakra's vibrations—helping you feel grounded, stable, and connected.

Embodiments of the beverage 200 can be configured and adapted to cultivate a sense of stability, security, and confidence that anchors one's well-being by tuning into the various chakras.

### Systems and Methods for Producing Beverages Injected or Infused With Certain Frequencies

In accordance with at least one aspect of this disclosure, an apparatus 100 for preparing a beverage 200 with an infused frequency is shown in FIG. 1. The apparatus 100 a mixing vessel 102 configured to mix a liquid base 104 and one or more flavoring ingredients 106 together to generate a mixed liquid 108. The mixing vessel 102 can include a stirrer or agitator 110 to evenly mix the liquid base 104 with the flavoring ingredients 106. In certain embodiments, the liquid base 104 can be water and the flavoring ingredients 106 can be or include natural flavorings such as whole or muddled fruits or vegetables, fruits or vegetable extracts, botanicals, flowers, herbs, or extracts thereof, and/or natural sweeteners such as cane sugar.

In certain embodiments, the liquid base 104 can be or include crystal water, where the type of crystal used to make the crystal water based is selected as a function of the chakra to be balanced, or in other words, the crystal water can be selected based on a match to the predetermined frequency. In certain embodiments, any one or more of the flavoring ingredients 106 (e.g., botanicals) can be steeped in the liquid base 104 prior to, during, or after the mixing phase. As used herein crystal water can mean water infused with the energy and intentions of a particular or particular combination of crystals, which can enhance the advantageous properties of the beverage induced by the infused predetermined frequency.

In certain embodiments, the one or more flavoring ingredients provided to each respective mixing vessel can be selected as a function of the respective predetermined frequency. For example, certain flavoring ingredients are more compatible with balancing certain chakras when combined with the respective predetermined frequency. In certain embodiments, the base liquid and/or flavoring ingredients do not include alcohol and are not fermented, and the base liquid is not carbonated.

A bottling vessel 112 configured to deposit the mixed liquid 108 into a respective bottle 114 for consumption is included in the bottling apparatus 100 downstream of the mixing vessel 102. A pump 116 is disposed between the mixing vessel 102 and the bottling vessel 112 to draw the mixed liquid 108 from the mixing vessel 102 and provide the mixed liquid 108 to the bottling vessel 112. The pump 116 includes an inlet side 118 and an outlet side 120. A conduit 122 (e.g., a flexible tubing or piping) extends from the mixing vessel 102 to the bottling vessel 112, where a first portion 124 of the conduit 122 extends from the mixing vessel 102 to the inlet side 118 of the pump 116 and a second portion 126 of the conduit 122 extends from the outlet side 120 of the pump 116 to the bottling vessel 112.

A vibration inducer 128 can be disposed in the first portion 124 of the conduit 122. An exemplary embodiment of the vibration inducer 128 is shown in FIG. 2. The vibration inducer 128 includes a diaphragm 130 configured to be placed in or proximate the mixed liquid 108 and a vibration generator 132 operatively connected to the diaphragm to drive the diaphragm at a predetermined frequency to induce a measurable pressure pulsation in the mixed liquid 108 before bottling. The vibration inducer 128 can further include an actuator 134 configured to drive the diaphragm 130 while the vibration generator 132 vibrates at the predetermined frequency. The actuator 134 can be a small actuator, such as an actuator having a stroke length of less than 10 mm, or a stroke length of less than 5 mm, or a stroke length of less than 4 mm. In certain embodiments, the actuator 134 can include a crystal. In certain embodiments, the actuator 134 can be or include a piezoelectric actuator.

In certain embodiments, the apparatus can further include a controller 136 configured to receive an instruction of the predetermined frequency and cause the vibration generator 132 to vibrate at the predetermined frequency. The predetermined frequency can be selected as a function of a desired healing effect of the beverage preparation, for example, the predetermined frequency can align with one of the seven main chakra frequencies.

The predetermined frequency is between 390 to 970 hz, for example, about 396 hz or about 417 hz or about 528 hz or about 639 hz or about 741 hz or about 852 hz or about 936 hz. In certain embodiments, the predetermined frequency is equal to one of 396 hz or 417 hz or 528 hz or 639 hz or 741 hz or 852 hz or 936 hz to align with one of the seven main chakra frequencies, e.g., the root chakra, the sacral chakra, the solar plexus chakra, the heart chakra, the throat chakra, the third eye chakra, and the crown chakra, respectively.

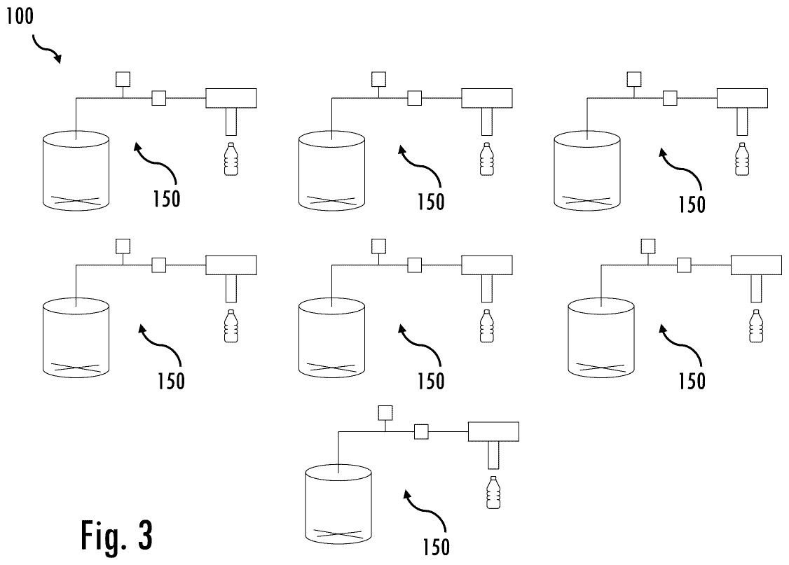

Referring now to FIG. 3, in certain embodiments, the mixing vessel 102, the bottling vessel 112, the pump 116, the vibration inducer 128, and the conduit 122 together can form a single bottling station 150. A shown in FIG. 3, the apparatus 100 can include a plurality of bottling stations 150 fluidly isolated from one another. Each respective vibration inducer 128 of each bottling station 150 can be configured to operate at a different respective predetermined frequency, e.g., each bottling station can be dedicated to bottling a beverage preparation having been infused with a different chakra frequency.

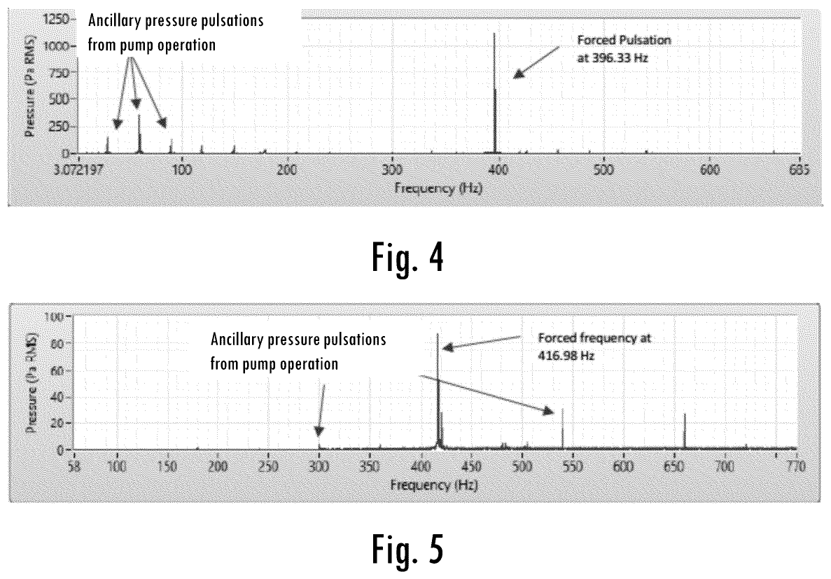

Referring now to FIGS. 4-10, spectra visualizing the pressure pulsation frequency included in the mixed liquid 108 measured by a pressure transducer while the transfer pump 116 is operating, and the vibration generator was vibrating at the predetermined frequencies are shown. In certain embodiments, such as shown in FIGS. 4 and 5, the measurable pressure pulsation induced via the vibration inducer is greater than an ancillary pressure pulsation induced by bottling equipment other than the vibration inducer. In certain embodiments, the measurable pressure pulsation induced via the vibration inducer is more than two times greater than an ancillary pressure pulsation induced due to other bottling equipment. It is noted that should any ancillary pressure pulsation be induced in the liquid by bottling equipment other than the vibration inducer, this ancillary pressure pulsation occurs at a frequency different than the predetermined frequency, and at a much lower magnitude and can therefore be ignored.

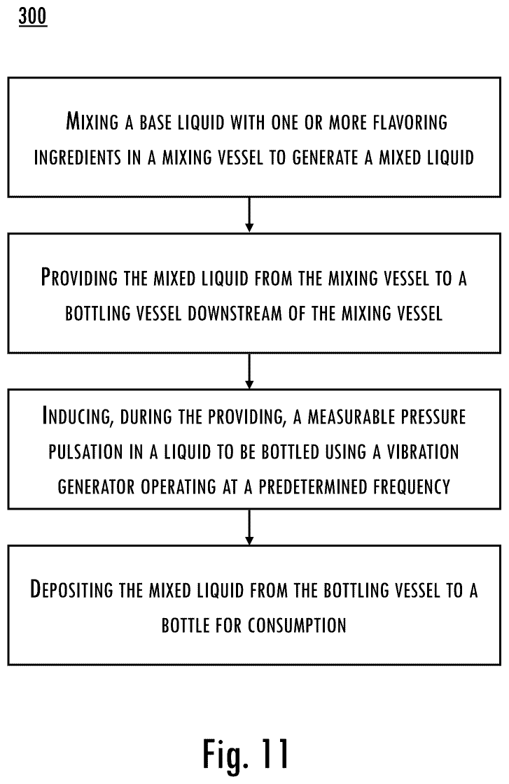

With reference now to FIG. 11, in accordance with at least one aspect of this disclosure, a method 300 for preparing a beverage (e.g. a beverage 200) with an infused frequency is shown. The method 300 can include the steps of inducing, during a bottling process, a measurable pressure pulsation in a liquid to be bottled using a vibration generator operating at a predetermined frequency. The method can further include mixing a base liquid with one or more flavoring ingredients in a mixing vessel to generate a mixed liquid, providing the mixed liquid from the mixing vessel to a bottling vessel downstream of the mixing vessel, and depositing the mixed liquid from the bottling vessel to a bottle for consumption. In certain embodiments, the inducing step occurs during the providing step, i.e., after the mixing step and before the bottling step, upstream of any pump used to provide the mixed liquid from the mixing vessel to the bottling vessel. In certain embodiments, the inducing step can utilize any one or more embodiments of a vibration inducer (e.g., vibration inducer 128) as described herein. In certain embodiments, the predetermined frequency induced in the liquid can be one of about 396 hz or about 417 hz or about 528 hz or about 639 hz or about 741 hz or about 852 hz or about 936 hz.

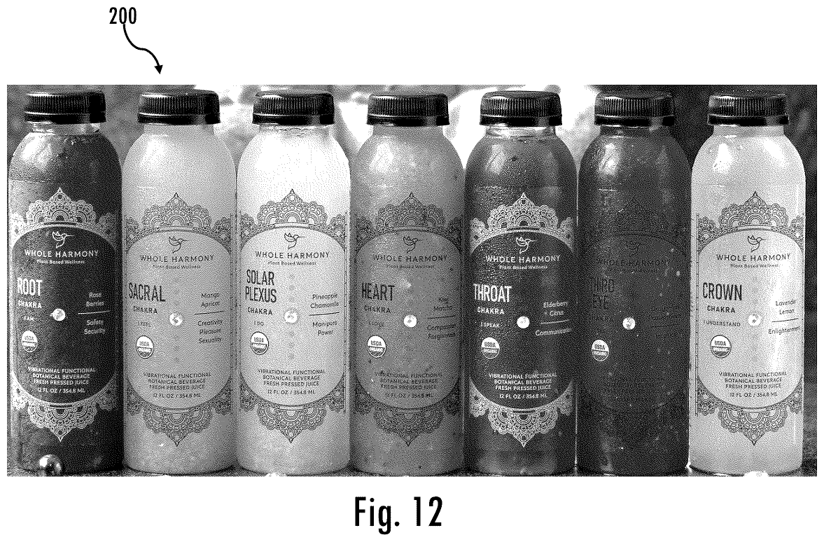

In accordance with at least one aspect of this disclosure, a novel beverage preparation 200 is provided. FIG. 12 shows seven exemplary beverage preparations made by the method as shown and described. The beverage preparation 200 can include a base liquid mixed with one or more flavoring ingredients and can further include an infused frequency configured to promote healing of one of the seven main chakras as a function of the infused frequency. As shown in FIG. 12, each exemplary beverage preparing 200 can align with one of the seven chakras as a function of the frequency infused therein. For example, each one of the exemplary beverages 200 shown in FIG. 12 can be prepared and bottled from one of the respective bottling stations 150 shown in FIG. 3. Healing properties of the beverage may include promoting sensations of improved physical health, emotional well-being, and spiritual growth. Embodiments of the beverage preparation 200 can be made by any one or more of the embodiments of the process described herein and using any one or more embodiments of the bottling apparatus shown and described herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. An apparatus for preparing a beverage with an infused frequency, comprising:
a vibration inducer including:
a diaphragm configured to be placed in or proximate a liquid being bottled;
a vibration generator operatively connected to the diaphragm to drive the diaphragm at a predetermined frequency to induce a measurable pressure pulsation in the liquid being bottled; and
a controller configured to receive an instruction of the predetermined frequency and cause the vibration generator to vibrate at the predetermined frequency.

2. The apparatus of claim 1, wherein the vibration inducer includes an actuator having a stroke length of less than 10 mm.

3. The apparatus of claim 2, wherein the vibration inducer includes an actuator having a stroke length of less than 5 mm.

4. The apparatus of claim 3, wherein the vibration inducer includes an actuator having a stroke length of less than 4 mm.

5. The apparatus of claim 1, wherein the measurable pressure pulsation induced via the vibration inducer is greater than an ancillary pressure pulsation induced by bottling equipment other than the vibration inducer.

6. The apparatus of claim 5, wherein the measurable pressure pulsation induced via the vibration inducer is more than two times greater than an ancillary pressure pulsation induced bottling equipment other than the vibration inducer.

7. The apparatus of claim 1, wherein any ancillary pressure pulsation induced by bottling equipment other than the vibration inducer occurs at a frequency different than the predetermined frequency.

8. The apparatus of claim 1, wherein the predetermined frequency is between 390 to 970 hz.

9. The apparatus of claim 1, wherein the predetermined frequency is one of about 396 hz or about 417 hz or about 528 hz or about 639 hz or about 741 hz or about 852 hz or about 936 hz.

10. The apparatus of claim 9, wherein the predetermined frequency is equal to one of 396 hz or 417 hz or 528 hz or 639 hz or 741 hz or 852 hz or 936 hz.

11. The apparatus of claim 1, further comprising:
a mixing vessel configured to mix a liquid base and one or more flavoring ingredients together to generate a mixed liquid;
a bottling vessel configured to deposit the mixed liquid into a respective bottle for consumption; and
a pump disposed between the mixing vessel and the bottling vessel to draw the mixed liquid from the mixing vessel and provide the mixed liquid to the bottling vessel, wherein the pump includes an inlet side and an outlet side.

12. The apparatus of claim 11, wherein the vibration inducer is positioned upstream of the inlet side of the pump.

13. The apparatus of claim 12, further comprising: a conduit extending from the mixing vessel and the bottling vessel, wherein a first portion of the conduit extends from the mixing vessel to the inlet side of the pump and wherein a second portion of the conduit extends from the outlet side of the pump to the bottling vessel, wherein the vibration inducer is disposed in the first portion of the conduit.

14. The apparatus of claim 13, wherein the mixing vessel, the pump, the bottling vessel, the vibration inducer, and the conduit together form a bottling station, and further comprising:
a plurality of bottling stations fluidly isolated from one another, wherein each respective vibration inducer is configured to vibrate at a different respective predetermined frequency.

15. The apparatus of claim 14, wherein the respective predetermined frequencies are equal to 396 hz, 417 hz, 528 hz, 639 hz, 741 hz, 852 hz, 936 hz.

16. The apparatus of claim 15, wherein the one or more flavoring ingredients provided to each respective mixing vessel are selected as a function of the respective predetermined frequency.

17. A method for preparing a beverage with an infused frequency, comprising the steps of:
inducing, during a bottling process, a measurable pressure pulsation in a liquid to be bottled using a vibration generator operating at a predetermined frequency.

18. The method of claim 17, further comprising the steps of:
mixing a base liquid with one or more flavoring ingredients in a mixing vessel to generate a mixed liquid;
providing the mixed liquid from the mixing vessel to a bottling vessel downstream of the mixing vessel; and
depositing the mixed liquid from the bottling vessel to a respective bottle for consumption,
wherein the inducing step occurs during the providing step.

19. The method of claim 18, wherein the predetermined frequency is one of about 396 hz or about 417 hz or about 528 hz or about 639 hz or about 741 hz or about 852 hz or about 936 hz.

20. A beverage preparation having been infused with a frequency, made by the method of claim 19.
